(19) United States
(12) Patent Application Publication
(10) Pub. No.: US 2008/0180937 A1
(43) Pub. Date: Jul. 31, 2008

(54) Patio umbrella light

(76) Inventor: Chris Pengelly, Toronto (CA)

Correspondence Address: Elias C. Borges, Suite 406, 555 Burnhamthorpe Road, Toronto, ON, M9C 2Y3, omitted

(21) Appl. No.: 11/698,838

(22) Filed: Jan. 29, 2007

(51) Int. Cl. F21V 33/00; A45B 3/02

(52) U.S. Cl. 362/85; 362/102

(57) ABSTRACT

The present invention is a lighting system for a patio umbrella of the type having a central post supporting a plurality of radiating arms. The system includes a plurality of LED arrays, each array having a plurality of LEDs mounted on a housing having opposite first and second sides. The LEDs of the array are mounted on the first side of the housing and are oriented to project light in one direction. The housing has at least one mounting strap for mounting the housing to one of the radiating arms such that the second side of the housing abuts against the radiating arm and the LEDs are oriented downwardly. Each array has an elongated electrical cable for supplying the LED array with electric power. The system further includes a control module having a battery pack coupled to an LED control circuit. The LED control circuit is configured to drive the LED arrays, the control module having at least one mounting strap dimensioned and configured to mount the control module to the central post. The central control module has a cable coupled to the LED control circuit, the cable being coupled to each of the LED arrays by a wiring harness configured to couple to the electrical cables of the LED arrays.

### FIELD OF THE INVENTION

The invention relates generally to light fixtures which attach to patio umbrellas.

### BACKGROUND OF THE INVENTION

Patio umbrellas are a common fixture on patios and gardens. They are often mounted to a patio table or the like. During the day, the patio umbrella shelters individuals seated beneath the umbrella from direct sunlight. However, during the night, people often congregate underneath patio umbrellas. In order to increase the enjoyment people experience by congregating underneath patio umbrellas after dark, several attempts have been made to provide illuminated patio umbrellas. Typically, this has involved mounting one or more lights under the umbrella which are coupled to long electrical cords. The electrical cord can then be plugged in to provide the electrical power needed to drive the electric lights. A few patio umbrella lighting systems have been described which include a light which is mounted to the vertical support column of the umbrella. These lighting systems are adequate, but since they use a single lamp mounted to the central post, the light generated by the lamp tends to be harsh and unappealing. Furthermore, retrofitting an existing patio umbrella with such a system is cumbersome because the light fixture tends to be large and bulky. An improved lighting system for patio umbrellas is therefore required, preferably a system which is easy to retrofit on existing patio umbrellas and which produces an even and pleasing lighting effect.

### SUMMARY OF THE INVENTION

In accordance with one aspect of the present invention, there is provided a lighting system for a patio umbrella which overcomes the disadvantages of the prior art. The system is for use with patio umbrellas of the type having a central post supporting a plurality of radiating arms. The system includes a plurality of LED arrays, each array having a plurality of LEDs mounted on a housing having opposite first and second sides. The LEDs of the array are mounted on the first side of the housing and are oriented to project light in one direction. The housing has at least one mounting strap for mounting the housing to one of the radiating arms such that the second side of the housing abuts against the radiating arm and the LEDs are oriented downwardly. Each array has an elongated electrical cable for supplying the LED array with electric power. The system further includes a control module having a battery pack coupled to an LED control circuit. The LED control circuit is configured to drive the LED arrays, the control module having at least one mounting strap dimensioned and configured to mount the control module to the central post. The central control module has a cable coupled to the LED control circuit, the cable being coupled to each of the LED arrays by a wiring harness configured to couple to the electrical cables of the LED arrays.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a side view of a lighting system made in accordance with the present invention mounted to a patio umbrella.

In the drawings like characters of reference indicate corresponding parts in the different figures.

### DETAILED DESCRIPTION OF THE INVENTION

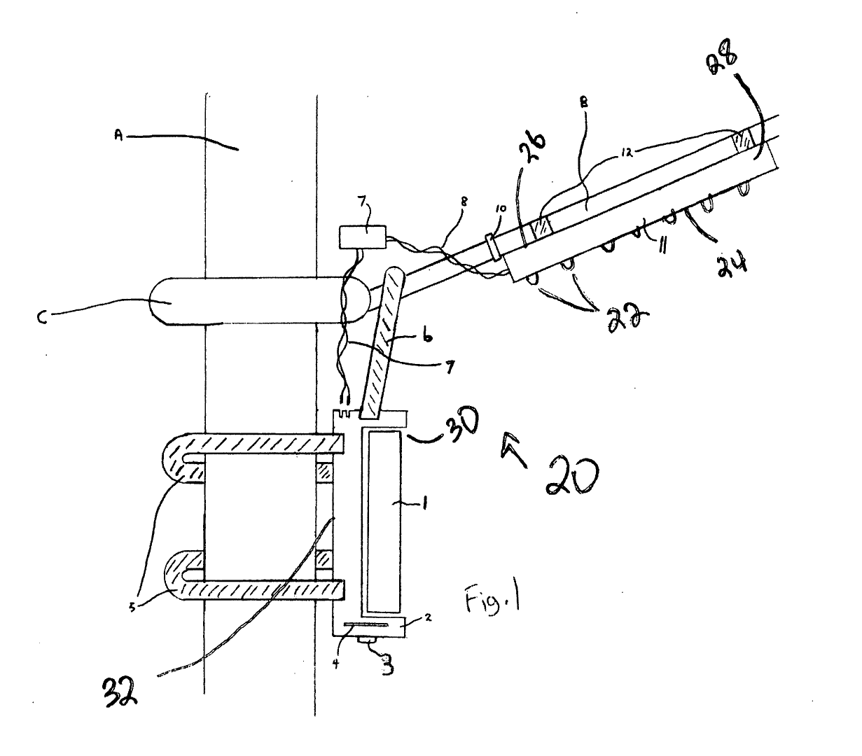

Referring firstly to FIG. 1, the present invention is for use with patio umbrellas of the type having a central support column A which supports a plurality of radiating arms B. Radiating arms B are pivotally mounted to a central ring C which is in turn mounted on the umbrella's central column A to permit the radiating arms to be extended or retracted by simply raising or lowering the central ring, respectively.

The lighting system, shown generally as item 20, consists of a plurality of LED arrays 11 electrically coupled to central control module 2. Each LED array 11 consists of an elongated housing 28 having opposite sides 24 and 26. A plurality of LEDs 22 are mounted onto side 24 of housing 28 and arranged in at least one row extending along the length of housing 28. Flexible straps 12 are mounted on either end of housing 28 and are provided with hook and loop (Velcro™) fasteners to permit the housing to be mounted to radiating arm B such that side 26 is facing the radiating arm and LEDs 22 are oriented downwardly. Rubber stop 10 is mounted to radiating arm B between LED array 11 and central column A to prevent the LED array from moving along radiating arm B. LED array has an elongated electrical cable 8 which electrically couples to wiring harness 7. Electrical cable 8 is electrically coupled to LEDs 22 to provide them with electrical power to light up.

Control module 2 comprises a housing having a back wall 32 and a battery compartment 30 opposite back wall 32. Battery compartment 30 holds a rechargeable electric battery 1. Control module 2 further includes an LED control circuit 4 which is coupled to electric battery 1 LED control circuit 4 is electrically coupled to switch 3 and to cable 9 which is in turn coupled to wiring harness 7; hence, the LED control circuit is electrically coupled to LED's 22 of LED array 11. LED control circuit 4 is configured to drive LED's 22 using electrical power from battery 1, preferably by flashing the LED's on and off very rapidly. LED control circuit 4 would be provided with an LED driver circuit, or some other suitable circuit for driving the LEDs while drawing a minimum of power from battery 1. Suitable drive circuits are available on the market. It will be appreciated that any suitable combination of electric battery and LED drive circuit can be used with the system. For example, a typical system may use 4 AA sized rechargeable batteries, or two C sized rechargeable batteries.

Control unit 2 is provided with straps 5 for mounting the control unit to umbrella column A such that back side 32 is facing column A and battery compartment 30 is facing away from the central column. Straps 5 are preferably provided with hook and loop fasteners and are sufficiently long to permit unit 2 to freely slide up and down on column A. Control unit 2 is further provided with elongated strap 6 to permit the control unit to be mounted to one of the radiating arms B such that the control unit suspends from the radiating arm and can slide up and down column A as the arms are extended and retracted.

The present invention has several advantages over the prior art. Firstly, the device can be easily retro-fitted onto an existing patio umbrella. Secondly, once installed, the user can still operate the umbrella to deploy or retract the umbrella's radiating arms without interference from the control unit because the control unit slides up and down on the umbrella's central column. The light generated by the LED arrays is more diffuse since the LEDs are arranged in long rows along the radiating arms. Since the LEDs are directed downwardly, the light produced by the LED is more efficiently oriented and battery life is thereby extended. Finally, the battery is easily accessible without having to remove the control unit since the battery compartment is oriented away from the central support column of the umbrella.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A lighting system for a patio umbrella of the type having a central post supporting a plurality of radiating arms, the system comprising:
a plurality of LED arrays, each array having a plurality of LEDs mounted on a housing having opposite first and second sides, the LEDs being mounted on the first side of the housing to project light in one direction, the housing having at least one mounting strap for mounting the housing to one of the radiating arms such that the second side of the housing abuts against the radiating arm and the LEDs are oriented downwardly, each array having an elongated electrical cable for supplying the LED array with electric power;
a control module having a battery pack coupled to an LED control circuit, the LED control circuit being configured to drive the LED arrays, the control module having at least one mounting strap dimensioned and configured to mount the control module to the central post, the central control module having a cable coupled to the LED control circuit, the cable being coupled to each of the LED arrays by a wiring harness configured to couple to the electrical cables of the LED arrays.

2. The lighting system of claim 1 wherein the control module further comprises a second mounting strap dimensioned and configured to mount the control module to one of the radiating arms.

3. The lighting system of claim 1 further comprising a stop member mounted to each radiating arm to which an LED array is mounted to, the stop member being mounted to the radiating arm between the LED array and the central post, the stop member being dimensioned and configured to stop the LED array from sliding towards the central post.

4. The lighting system of claim 1 wherein the mounting straps each comprise hook and loop fasteners.

5. The lighting system of claim 1 wherein each LED array comprises an elongated structure having at least one row of LEDs extending along the first side of the housing.

6. A lighting system for a patio umbrella of the type having a central post supporting a plurality of radiating arms, the system comprising:
a plurality of LED arrays, each array having a plurality of LEDs mounted on a housing having opposite first and second sides, the LEDs being mounted on the first side of the housing and oriented to project light in one direction, the housing having at least one mounting strap for mounting the housing to one of the radiating arms such that the second side of the housing abuts against the radiating arm and the LEDs are oriented to project light downwardly;
a control module having a battery pack coupled to an LED control circuit, the LED control circuit being electrically coupled to the LED arrays and being configured to drive the LED arrays, the control module having at least one mounting strap dimensioned and configured to slidingly mount the control module to the central post such that the control module can slide up and down the central post.

7. The lighting system of claim 6 wherein each of the LED arrays comprise an elongated structure having at least one row of LEDs extending along the first side of the housing.

8. The lighting system of claim 6 wherein each of the LED arrays includes an electrical cable, the electrical cables from the LED arrays radiating from a central wiring harness, the central wiring harness being coupled to the LED control circuit by a main electrical cable.

9. The lighting system of claim 8 wherein each of the LED arrays comprise an elongated structure having at least one row of LEDs extending along the first side of the housing.

10. The lighting system of claim 6 wherein the control module further comprises a second mounting strap dimensioned and configured to mount the control module to one of the radiating arms.

11. The lighting system of claim 9 wherein the control module further comprises a second mounting strap dimensioned and configured to mount the control module to one of the radiating arms.

12. The lighting system of claim 6 wherein the control module has a back wall and wherein the battery pack is removably contained in a battery compartment opposite the back wall and wherein the mounting straps on the control module mount the control unit to the central post such that the back wall faces the central post and the battery compartment is oriented away from the central post.

13. The lighting system of claim 1 wherein the control module has a back wall and wherein the battery pack is removably contained in a battery compartment opposite the back wall and wherein the mounting straps on the control module mount the control unit to the central post such that the back wall faces the central post and the battery compartment is oriented away from the central post.

12. A lighting system for a patio umbrella of the type having a central post supporting a plurality of radiating arms, the system comprising:
a plurality of LED arrays, each array having an elongated row of LEDs mounted on an elongated housing having opposite first and second sides, the LEDs being mounted on the first side of the housing and oriented to project light in one direction, the housing having at least one mounting strap for mounting the housing to one of the radiating arms such that the LED array is suspended from the radiating arm with the second side of the housing abutting against the radiating arm and the LEDs are oriented downwardly, each array having an elongated electrical cable for supplying the LED array with electric power;
a control module having a removable battery pack contained in a battery compartment, the battery pack being coupled to an LED control circuit, the LED control circuit being configured to drive the LED arrays, the control module having a first mounting strap dimensioned and configured to mount the control module to the central post such that the control module can slide up and down the central post and the battery compartment is oriented away from the central post, and the control module having a second mounting strap dimensioned and configured to mount the control module to one of the radiating arms, the central control module having a cable coupled to the LED control circuit, the cable being coupled to each of the LED arrays by a wiring harness configured to couple to the electrical cables of the LED arrays.
